(19) United States
(12) Patent Application Publication
(10) Pub. No.: US 2007/0179794 A1
(43) Pub. Date: Aug. 2, 2007

(54) Internet based credential management system

(76) Inventors: Jamie Fisher, Ottawa (CA); Janet Wilkinson, Ottawa (CA)

Correspondence Address: JAECKLE FLEISCHMANN & MUGEL, LLP, 190 Linden Oaks, ROCHESTER, NY, 14625-2812, US

(21) Appl. No.: 11/336,537

(22) Filed: Jan. 20, 2006

(51) Int. Cl. H04L 9/32

(52) U.S. Cl. 705/1; 726/6

(57) ABSTRACT

A secure credential management system (CMS) receives a document over the internet from an issuing institution and stores the document in a credential repository in an inbox associated with the person to which the document pertains. The CMS notifies the person that a document pertaining to him or her is at the credential repository. The person can then go to the credential repository, verify his or her identity, view the document, and create a permission for a third party to view the document. The CMS notifies the third party of the availability of the document along with a password to allow the third party to view and download the document. The institution cannot delete the document once the document has been sent to the credential repository, but can view the document and issue a corrected document if necessary. The user cannot alter the documents or create counterfeit documents.

### TECHNICAL FIELD

The present invention relates to document repositories, and more particularly to document repositories accessible through the internet.

### BACKGROUND OF THE INVENTION

Various individuals, such as job seekers and licensing applicants, are often required to provide credential type documents such as college transcripts that have been authenticated by the issuing institution. The individual usually requests that the issuing institution send certified copies of the documents directly to third parties such as potential employers or state licensing organizations.

Such requests require the issuing institution to access their records, copy or generate them, provide the proper certification, and mail the copies to the third party.

As a result the institutions must have adequate personnel, equipment, and space to process such requests. Moreover, often a single individual may need to provide multiple requests for the same document to multiple third parties.

Providing a repository accessible through the internet which would hold certified copies of such documents and issue copies of the documents directly to third parties would obviate much of the burden of the issuing institution in providing these documents. The issuing institution would only need to place a certified copy of transcripts into the repository, and the individual would provide the third party with a permission to view the documents. Moreover, the third party would receive a permission to view the documents within a day or two rather than having to wait several weeks for the institution to process the request for the certified document.

### SUMMARY OF THE INVENTION

Briefly described, a method of managing a document includes depositing the document in a repository of a document management system by a document issuer and notifying a person associated with the document of the existence of the document in the repository by the document management system. The person registers with the document management system and a third party is notified of the availability of the document by the document management system in response to a request from the person to make the document available to the third party. The third party is provided access to the document stored in the repository.

Also briefly described is a method of managing a credential which includes depositing the credential in a repository of a credential management system by a document issuer and notifying a person associated with the credential of the existence of the credential in the repository by the credential management system. The person registers with the credential management system and a third party is notified of the availability of the credential by the credential management system in response to a request from the person to make the credential available to the third party. The third party is provided access to the credential stored in the repository.

### BRIEF DESCRIPTION OF THE DRAWINGS

The present invention will now be described, by way of example, with reference to the accompanying drawings, in which:

FIG. 1 is a relational diagram of a preferred embodiment of a credential management system according to the present invention;

FIG. 2A is a flow chart of the communication between a credential management system and a document issuer in the preferred embodiment of the present invention;

FIG. 2B is a flow chart of the communication between a credential management system and a box holder in the preferred embodiment of the present invention;

FIG. 2C is a flow chart of the communication between a credential management system and a viewer in the preferred embodiment of the present invention;

FIG. 3 is an internet browser display of a log on screen for a document issuer;

FIG. 4 is an internet browser display of a screen presented to a document issuer after the document issuer logs on;

FIG. 5 is an internet browser display of a screen presented to a document issuer after the document issuer creates a new drawer;

FIG. 6 is an internet browser display of a screen presented to a document issuer to use to transfer documents to the credential repository;

FIG. 7 is an internet browser display of a screen presented to a document issuer after a document has been transferred to the document repository;

FIG. 8 is an e-mail display of an e-mail sent by the credential management system to a person who has had a first document transferred to the credential repository by a particular document issuer naming the person as the subject of the document;

FIG. 9 is an e-mail display of an e-mail sent by the credential management system to a person who has previously registered as a box holder with the credential management system for a particular document issuer;

FIG. 10 is an internet browser display of a screen presented to a person who has been notified that a first document for a particular document issuer has been deposited in the credential repository naming the person as the subject of the document;

FIG. 11 is an internet browser display of a verification screen presented to the person who has identified himself or herself on the screen shown in FIG. 10;

FIG. 12 is an internet browser display of a payment selection screen presented to the person who has successfully completed the verification on the screen shown in FIG. 11;

FIG. 13 is an internet browser display of a payment instruction screen;

FIG. 14 is an internet browser display of a first page of an account set up screen;

FIG. 15 is an internet browser display of a second page of an account set up screen;

FIG. 16 is an internet browser display of a screen presented to a box holder indicating that his or her account has been set up;

FIG. 17 is an internet browser display of a screen presented to a box holder showing the applicable document that has been deposited in the credential repository;

FIG. 18 is an internet browser display of a screen presented to a box holder after the box holder has accepted the relevant document;

FIG. 19 is an internet browser display of a screen presented to a box holder to allow the box holder to create a permission for a viewer to see the document;

FIG. 20 is an internet browser display of a screen presented to a box holder for entering the parameters of a permission;

FIG. 21 is an internet browser display of a screen presented to a box holder showing an updated list of the permissions window in FIG. 19;

FIG. 22 is an e-mail display of a first e-mail sent by the credential management system to a viewer that has a document ready for viewing;

FIG. 23 is an e-mail display of a second e-mail sent by the credential management system to a viewer that has a document ready for viewing;

FIG. 24 is an internet browser display of a screen presented to a viewer for logging onto the credential management system; and

FIG. 25 is an internet browser display provided by the credential management system of a document.

It will be appreciated that for purposes of clarity, and where deemed appropriate, reference numerals have often been repeated in the figures to indicate corresponding features.

### DESCRIPTION OF THE PREFERRED EMBODIMENTS

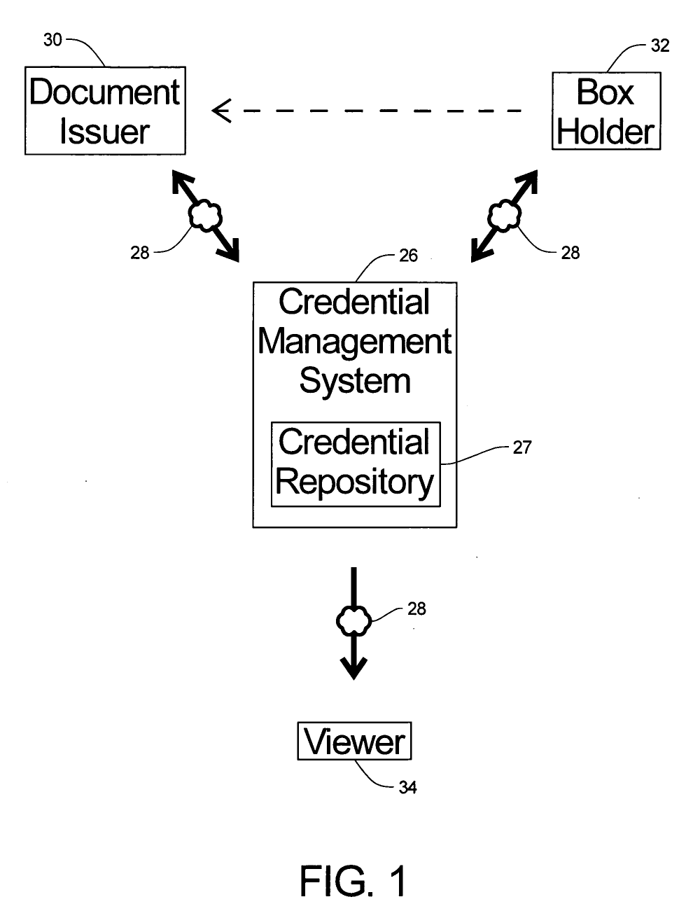

Turning now to the drawings, FIG. 1 is a relational diagram of a preferred embodiment of a credential management system 26 according to the present invention. A credential repository 27 connects over the internet 28 with a document issuer 30 that transfers documents to the credential repository 27. A box holder 32 connects over the internet 28 after a document pertaining to him or her has been deposited in the credential repository 27. The box holder 32 can view, delete and set up permissions for a viewer 34 to view a document but cannot modify or create a document. A viewer 34 connects over the internet 28 to log onto the credential management system 26 and to view the document for whom a box holder 32 has created a permission. In one mode of operation, as explained in more detail below, the box holder 32 will request that a document issuer 30 place a document into the credential repository 27. This request is indicated by the dotted line between the box holder 32 and the document issuer 30.

### Document Issuer Operation

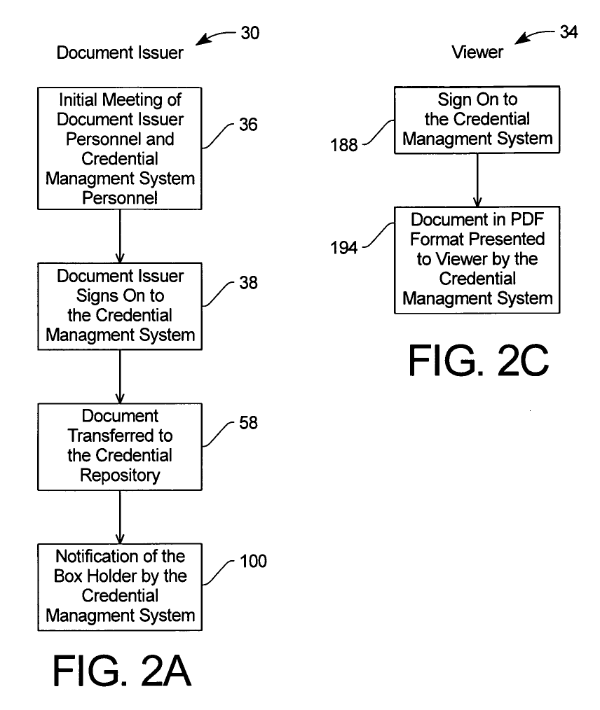

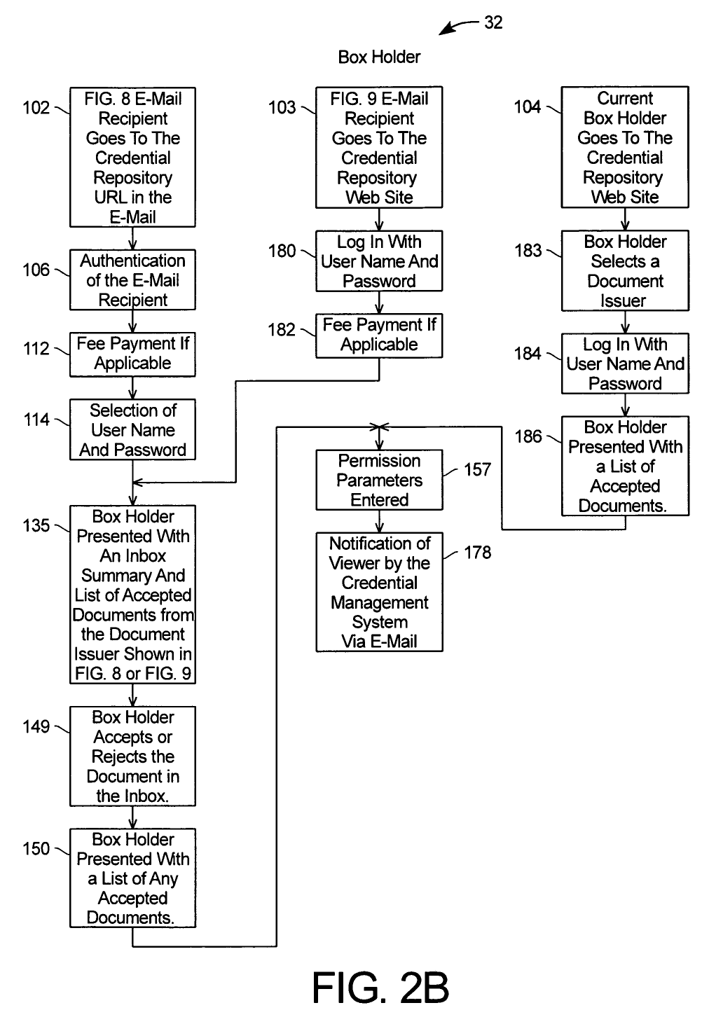

FIGS. 2A, 2B, and 2C are flow charts of the interactions between a credential management system 26 and a document issuer 30, a box holder 32, and a viewer 34, respectively, in the preferred embodiment of the present invention.

With reference to FIG. 2A once a document issuer 30, such as a university as in the example shown in FIGS. 3-25, has decided to use the credential management system 26, a face-to-face meeting is first held between the applicable personnel on the document issuer 30 and the applicable personnel of the credential management system 26 to register the document issuer 30 (represented by box 36). At this meeting the business arrangement between the credential management system 26 and the document issuer 30 are discussed along with the technical aspects of the transfer of data. Also at this meeting the document issuer 30 is assigned an organization name and password and the applicable person at the document issuer 30 is assigned a user name and personal password.

Next the document issuer 30 signs onto the credential management system 26 as represented by box 38.

FIG. 3 is an internet browser display of a log on screen for the document issuer 30. The screen shows a page 40 presented to the document issuer 30 when the document issuer 30 first goes to the credential management system's web site to transfer documents. The page 40 includes a top banner 42 identifying the credential management system's name along with their logo. In the main portion of the page is a document issuer 30 log on box 46 containing data entry boxes 48, 50, 52, and 54 for a person at the document issuer 30 to enter the document issuing organization's log on name, document issuing organization's password, the document issuing organization person's user log on name and the person's password, respectively (represented by box 38 in FIG. 2A). After the text entry has been completed, the “sign on” button 56 is clicked to proceed to the document transfer operation (represented by box 58 in FIG. 2A). All of the communications over the internet with the document issuing system is encrypted as indicated by the encryption icon 60 on the browser display shown in FIG. 3. Moreover, all of the documents and associated information is stored as encrypted data in the server at the document repository 27.

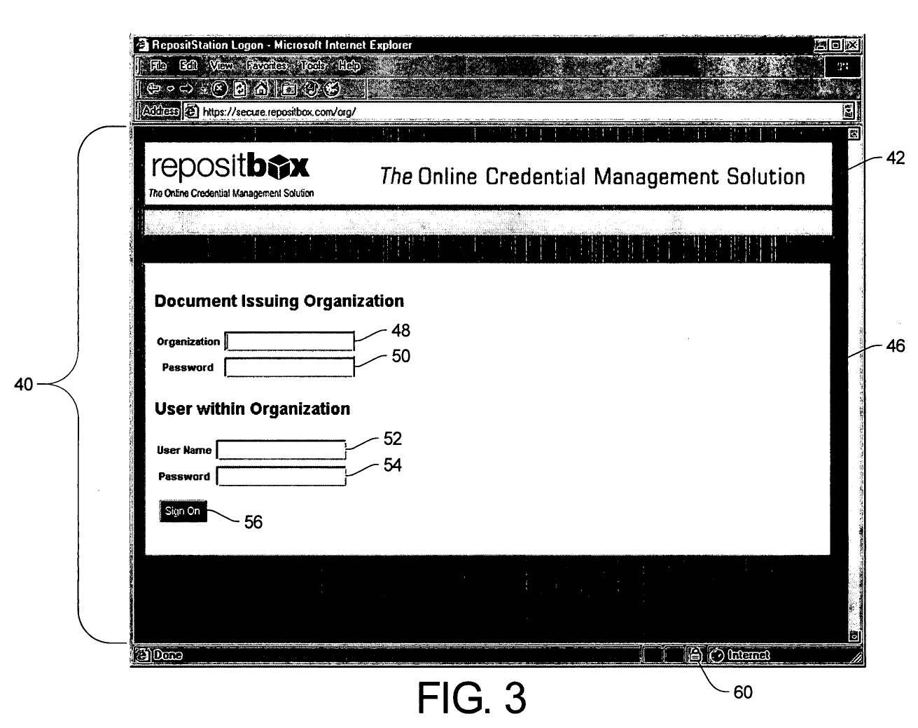

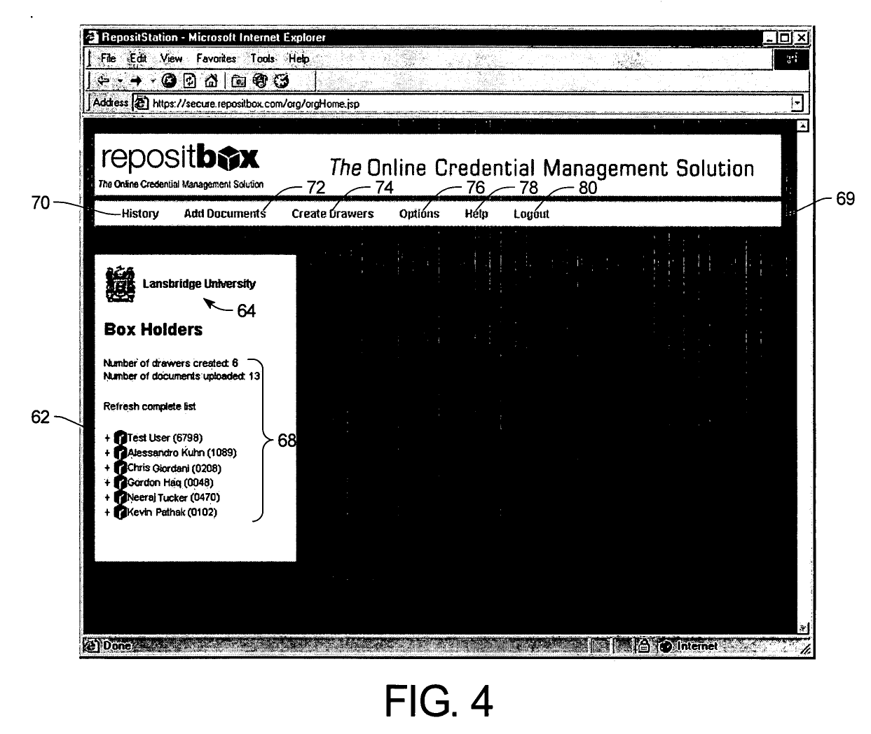

FIG. 4 is an internet browser display of a screen presented to the document issuer 30 after the document issuer logs on. A box holder summary box 62 in the main portion of the page shows the document issuing institution and logo 64, and a summary 68 of the document transfers made to date including the number of drawers created for individual box holders, the number of documents transferred to date, and a list of the box holders along with their student numbers. An options bar 69 has a list of six selections for the document holder to choose from. The six selections are “History” 70 to provide the transfer history to the document issuer 30, “Add Documents” 72 for the transferring documents to the credential repository 27, “Create Drawers” 74 for setting up a drawer for a new box holder, “Options” 76 for various data display and transfer options, “Help” 78 for assistance in using the credential management system 26, and “Logout” 80 to leave the system.

In the preferred embodiment the document issuer has the option of providing documents as either PDF files or providing documents as XML files of data to be applied to a template created by either the document issuing institution or by the credential management system 26. However, in general any type of files may be provided to transfer a document. In either case the box holder's name and authentication questions and answers (discussed below) must be provided to the document management system 26, and can be provided as part of the document download or by manually creating a drawer for a new box holder 32 and entering manually the authentication information. To create a drawer for a new box holder 32, the “Create Drawers” 74 button on the options bar 69 is clicked.

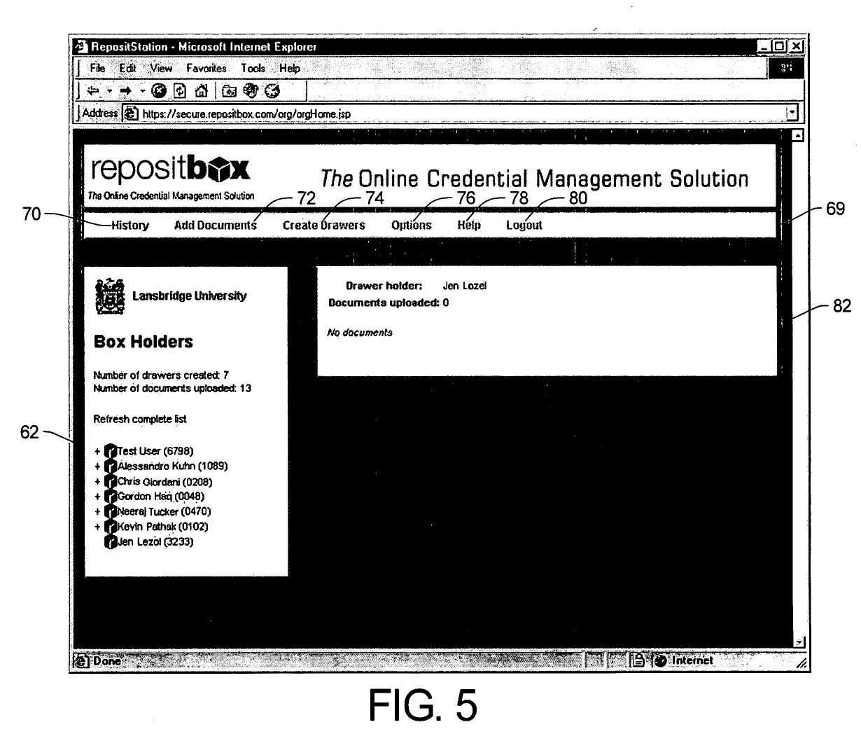

FIG. 5 is an internet browser display of a screen presented to the document issuer 30 after the document issuer 30 manually creates a new drawer. FIG. 5 is the same as FIG. 4 except that a new drawer status box 82 has been added listing the name of the new box holder 32 “Jen Lezol (3233).” The status box 82 also shows the status of the drawer created for the new box holder 32, which, of course, is empty when the drawer is first created. Also the new box holder's name and student number “Jen Lezol (3233)” has been added to the box holder summary box 62.

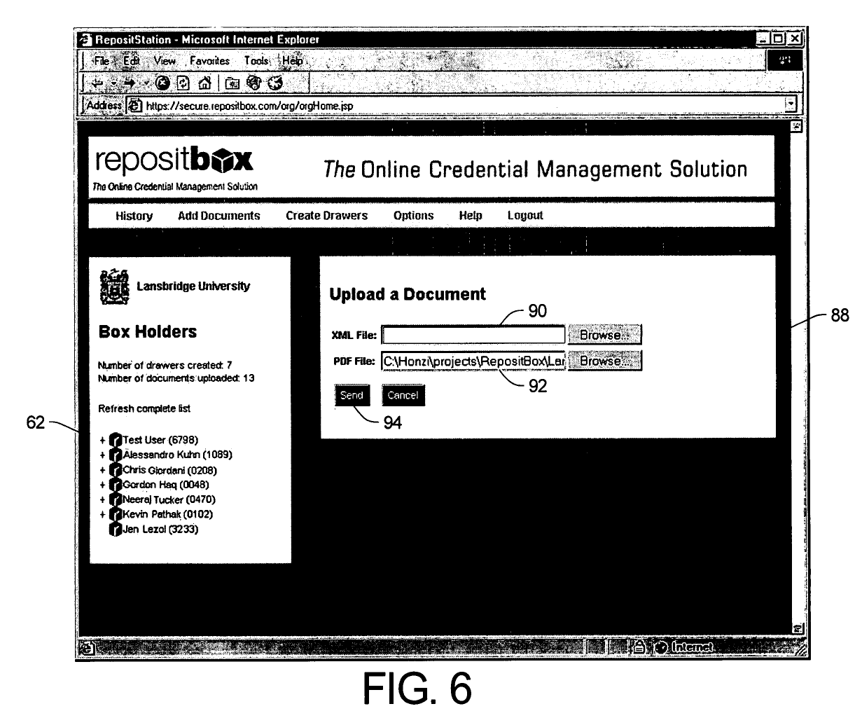

FIG. 6 is an internet browser display of a screen presented to the document issuer 30 to use to transfer documents to the credential repository 27. Upload a Document box 88 contains data entry boxes 90 and 92 for the document issuer 30 to insert the file name of the documents to be sent to the credential management system 26 using an XML format or a PDF format, respectively, in this embodiment. If the document itself does not identify the name of the box holder 32, then the document issuer person first clicks one of the names in the box holder summary box 62 to indicate the person associated with the document. Then the “Send” button 90 is clicked to upload the document.

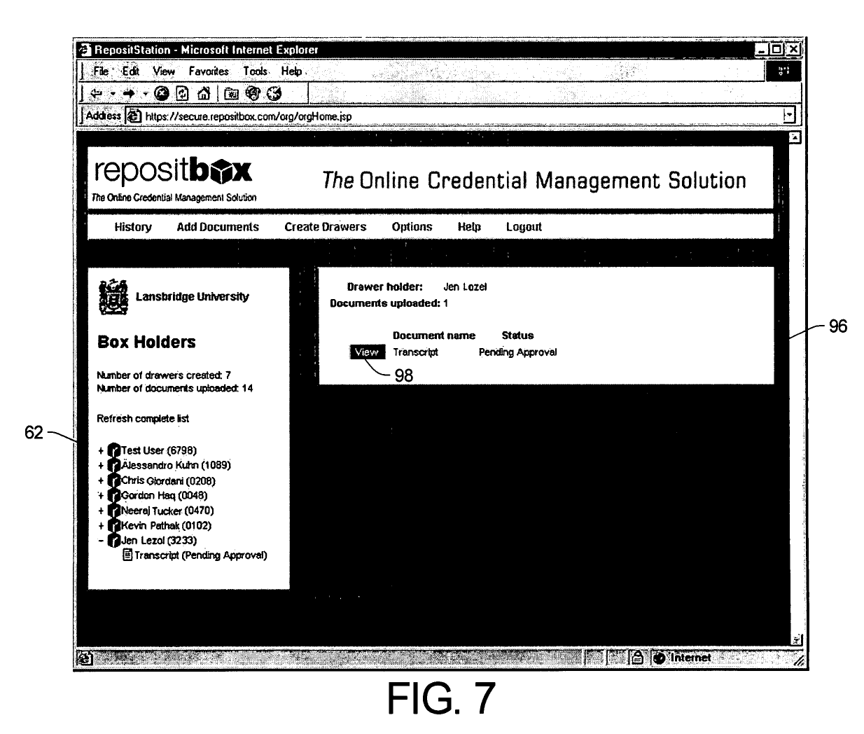

FIG. 7 is an internet browser display of a screen presented to the document issuer 30 after a document has been transferred to the credential repository 27. In this example the document was for box holder “Jen Lezol (3233)” as indicated in a transfer receive acknowledgement box 96. Also, in the box holder summary box 62 the name “Jen Lezol (3233)” now has a “−” to the left of the name, and a message under the name both indicating the name of the document that has been received and that it is pending approval. After a document has been viewed or accepted by a box holder 32, the “−” changes to a “+.” The pending approval status is also shown in box 96 along with a “view” button 98 for the document issuer 30 to view the document present in the credential repository 27.

Once a document issuer 30 has transferred a document to the credential repository 27, the document can not be deleted by the document issuer 30. This is akin to the situation when the document had been sent through the postal system. However, the document issuer 30 can view the document to detect if there is an error in the document. The document issuer 30 can then upload a second document, in this example a transcript, which would be a corrected transcript. The box holder 32 could then delete the first document and accept the second document as described below. The term “pending approval” in the box holder summary box 62 means that the box holder 30 for this particular document has not viewed or accepted the document. Thus the document issuer can monitor if a student has reviewed and accepted the document.

The credential management system 26 receives payment from the document issuer 30 and/or the box holder 32 depending on the agreement between the document issuer 30 and the credential management system 26. There are various scenarios for the fee payment arrangement. In a first scenario a document issuer 30 transfers a document either automatically (such as transferring a transcript after each student graduates) or at the request of a box holder 32, and the document issuer pays the credential management system 26 for each document transferred or for each document transferred and viewed or accepted by a box holder 32. When the fee is dependent on whether the box holder 32 accepts the document, the “pending approval” label in FIG. 7 provides information that can be used by the document issuer 30 to pay the credential management system 26 or to audit the statements from the credential management system 26. The document issuer 30 would collect the fees paid to the credential management system 26 as general student fees or as a specific fee for a request from a box holder 32 to transfer a document to the credential management system 26.

In a second scenario the credential management system 32 would collect a fee from each box holder for each document issuer 30 and share the payments received with the document issuer 30.

In these scenarios once a box holder 32 has accepted a document, he or she can provide the document to an unlimited number of potential employers, graduate schools, etc. without paying any additional fee to the document issuer.

In cases in which the document issuer 30 automatically transfers document to the credential repository 27 the document issuer 30 would probably elect to create XML files with a corresponding template. The XML file would be set up to include predefined data fields in a document issuer's computer records. The name of the potential box holder 32 and the questions to be asked a potential box holder 32 (described below) would be included in the XML document.

If a document issuer 30 transfers a document in a PDF format, the name and questions can be attached as annotations to the PDF file which would be available to the credential management system 26 as computer readable data. Alternatively, the document issuer 30 can manually enter the name of a box holder 30 along with the questions to be asked while at the web site of the credential repository 27 to create a drawer for a box holder 32 as described above.

After a document has been transferred to the credential repository 27 by the document provider 30, the box holder is notified by e-mail of the availability of the document (represented by box 100 in FIG. 2A).

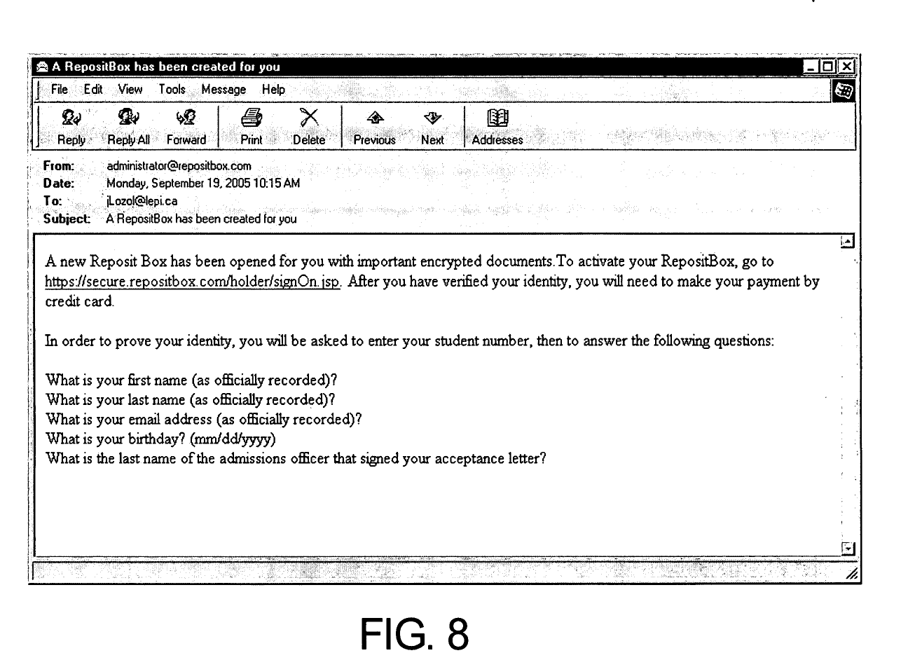

FIG. 8 is an e-mail display of an e-mail sent by the credential management system 26 to a person who has had a first document transferred to the credential repository 27 from a document issuer 30 naming the person as the subject of the document. The e-mail provides the person with the URL needed to view the new document, and also lists the questions that the person must answer to register with the credential repository 26 for that document issuer 30.

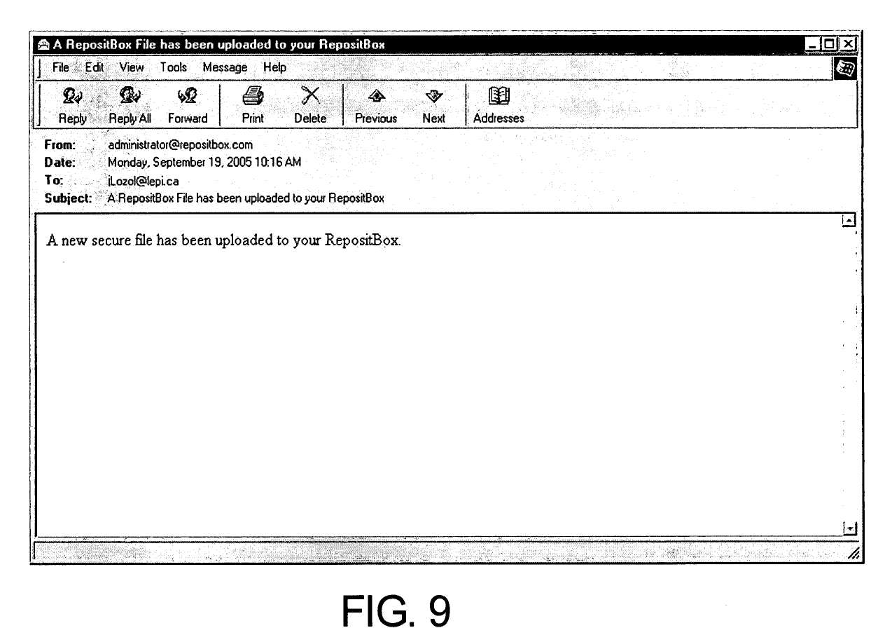

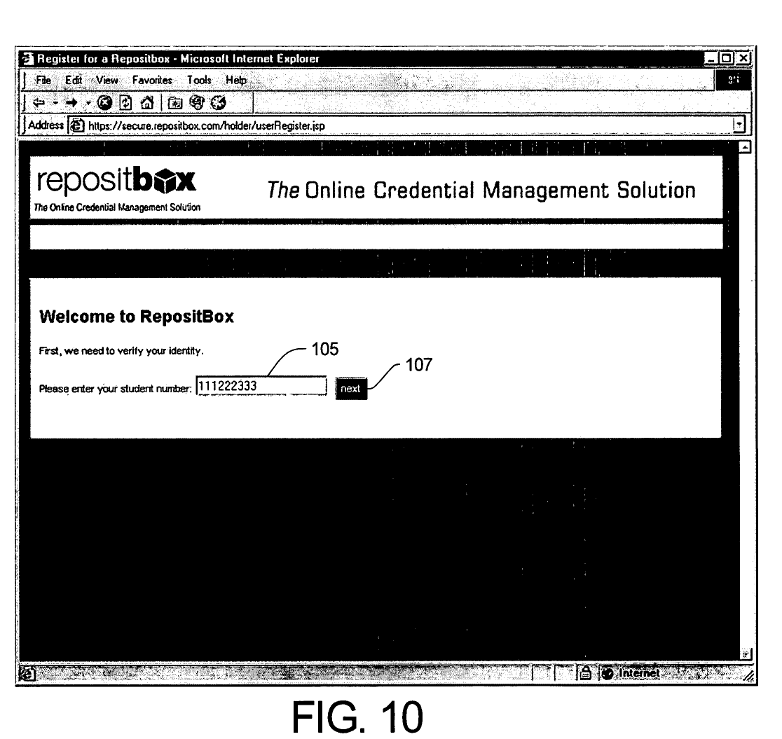

FIG. 9 is an e-mail display of an e-mail sent by the credential management system 26 to a person who has previously registered as a box holder with the credential management system 26 for the document issuer 30 that has transferred the document that generated the e-mail. This e-mail merely notifies the box holder that a new document has been transferred from a document issuer 30 that previously completed the authentication information that the document issuer 30 previously provided to the document repository 27.

It will be appreciated that a document issuer 30 using the credential management system 26 of the preferred embodiment receives at most only a single request from a box holder 32 for a particular document.

### Box Holder Operation

The first interaction between a recipient responding to an e-mail of the type shown in FIG. 8 and the credential management system 26 is represented by box 102 in FIG. 2B. A first interaction between a recipient responding to an e-mail of the type shown in FIG. 9 and the credential management system 26 is represented by box 103 in FIG. 2B. A first interaction between an existing box holder 32 who is not responding to either of the type of e-mails shown in FIGS. 8 or 9 and the credential management system 26 is represented by box 104 in FIG. 2B.

After the recipient of an e-mail of the type shown in FIG. 8 goes to the URL shown in the e-mail (represented by box 102 in FIG. 2B), the recipient is presented with the screen from an internet browser display shown in FIG. 10. FIG. 10 has a text box 105 to enter an identifier and begin the authentication process (represented by box 106 in FIG. 2B). In the example of a university document issuer 30 and a student or former student, the student is instructed to enter his or her student number. After a “next” button 109 is clicked, the identity of the student is verified.

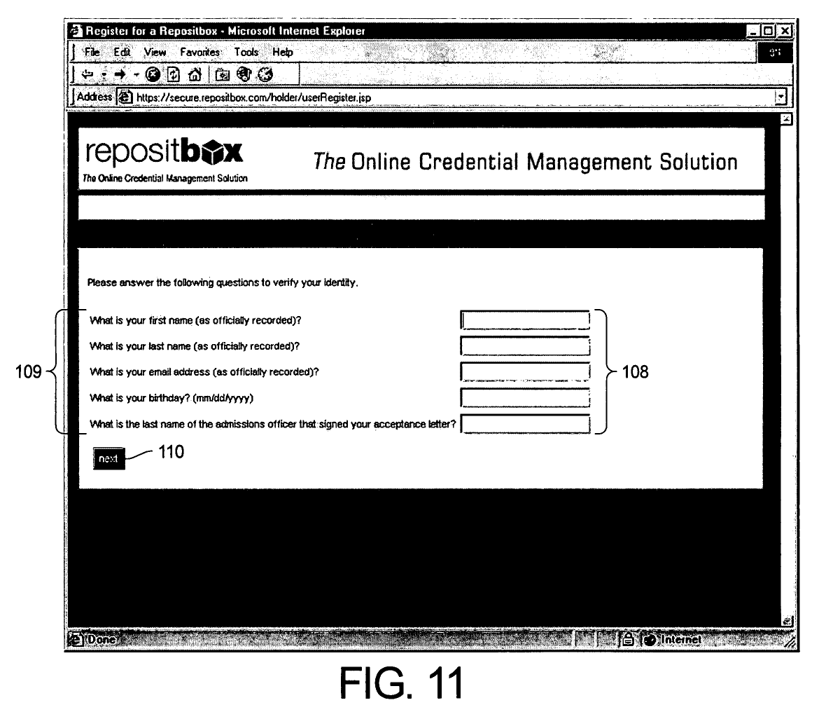

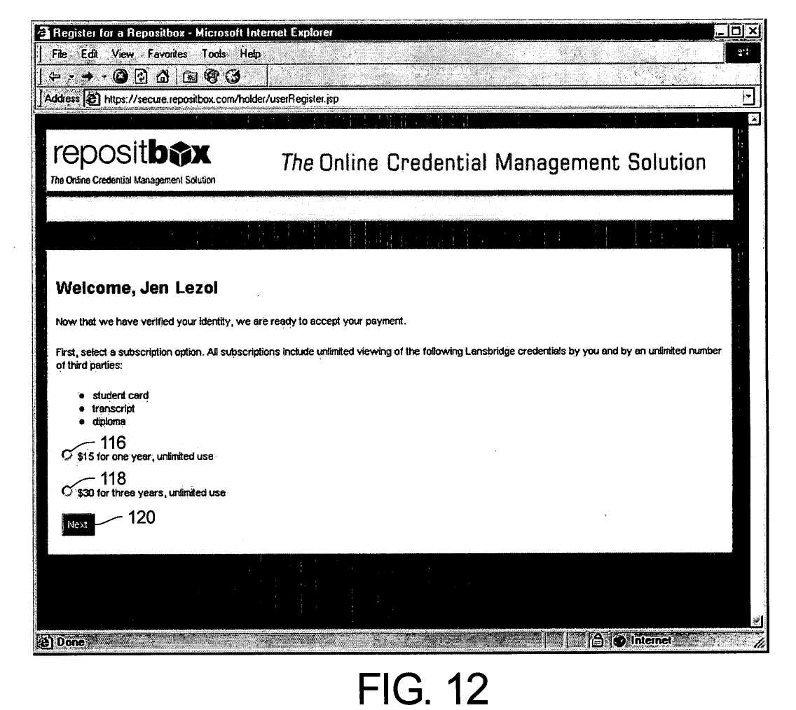

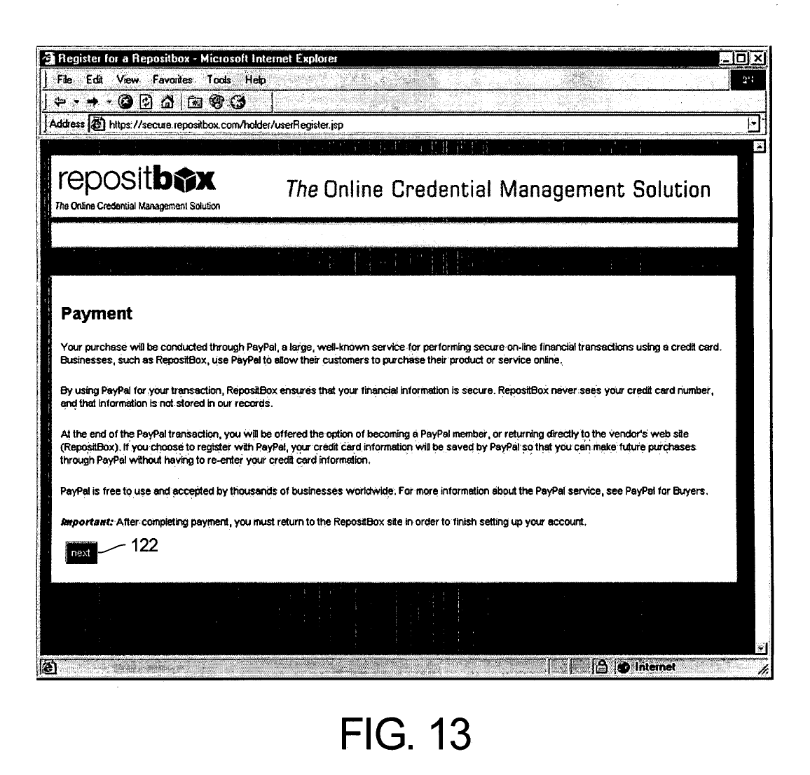

FIG. 11 is an internet browser display of a verification screen presented to the person who has identified himself or herself on the screen shown in FIG. 10. A column of text entry boxes 108 are used to answer the set of questions 109 provided by the document issuer 30 to verify the identity of the box holder 32. In this embodiment the questions asked were previously provided to the box holder 32 in the e-mail shown in FIG. 9. After the correct answers have been entered and a “next” button 110 is clicked, the box holder 32 fee paying process, if applicable, begins (represented by box 112 in FIG. 2B). If no fee is to be collected from the box holder 32, box 112 in FIG. 2B and the fee payment screens in FIGS. 12 and 13 are skipped, and the box holder 32 selects a username and a password (represented by box in FIG. 2B).

FIG. 12 is an internet browser display of a welcome screen and a payment selection screen presented to the person who has successfully completed the verification on the screen shown in FIG. 11 to begin the fee payment process if the box holder 32 is required to pay a fee. In this example the student is given the option of a one year or a three year subscription by clicking one of two radio buttons 116 and 118, respectively. After one of these options has been selected and a “next” button. 120 is clicked, the student is instructed how to make the payment.

FIG. 13 is an internet browser display of a payment instruction screen. When the box holder 32 reads the information and clicks a next button 122, the box holder 32 is transferred to the payment website, in this embodiment, the PayPal® website. The box holder 32 then returns to the credential repository's web site and selects his or her username and password (represented by box 114 in FIG. 2B).

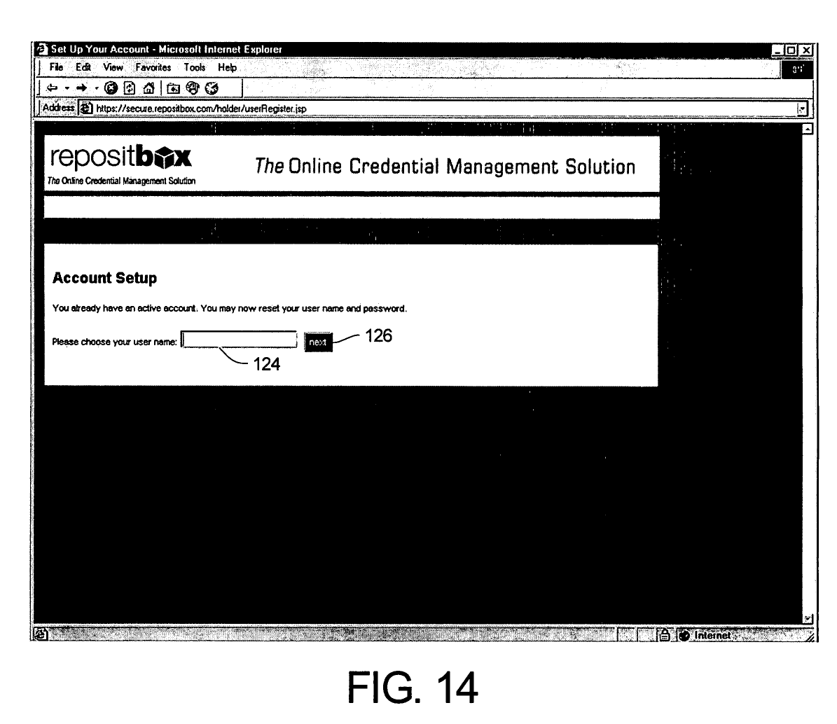

FIG. 14 is an internet browser display of a first page of an account set up screen having a text box 124 to enter a username. After a “next” button 126 is clicked, the box holder 32 moves on to a password selection screen.

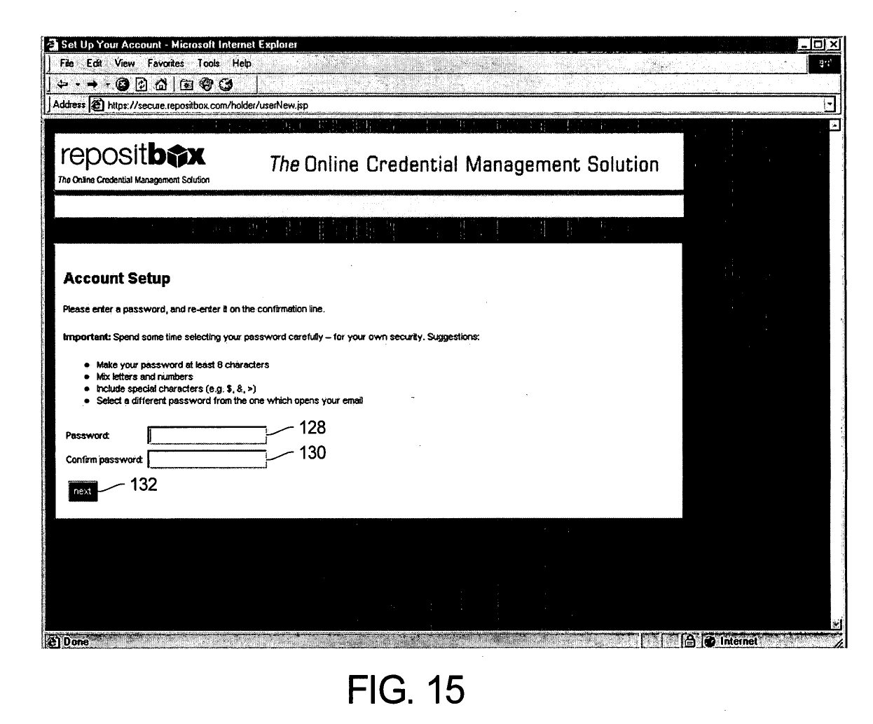

FIG. 15 is an internet browser display of the continuation of the account setup with instructions for selecting a password. Text boxes 128 and 130 are provided for entering the selected password twice. After a “next” button 132 is clicked, a confirmation screen is presented to the box holder 32.

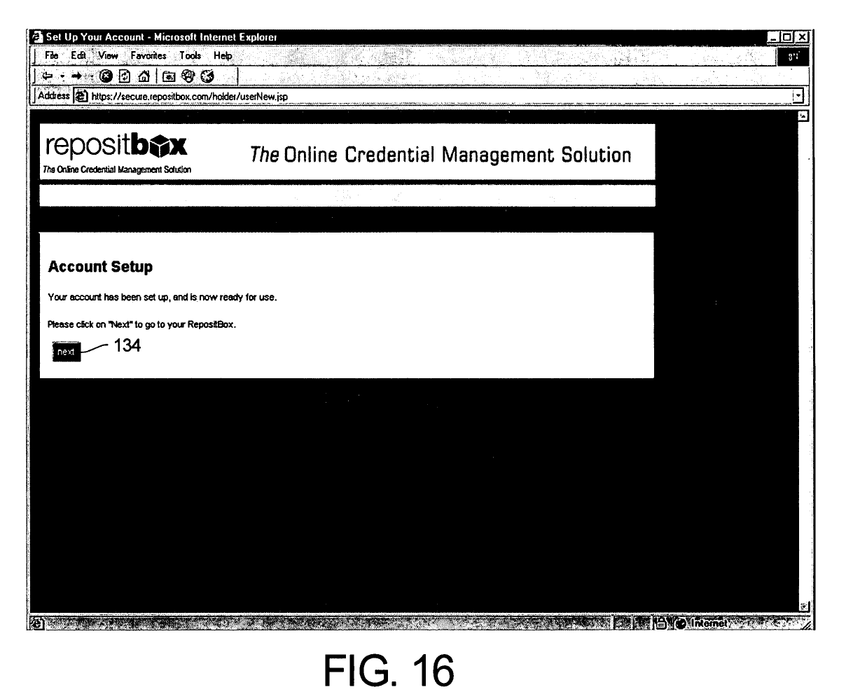

FIG. 16 is an internet browser display of a confirmation screen indicating that the box holder 32 has established an account with the credential management system 26. After a “next” button 134 is clicked, the box holder is given a summary of the documents in his or her inbox from the document issuer 30 shown in the FIG. 8 e-mail (represented by box 135 in FIG. 2B).

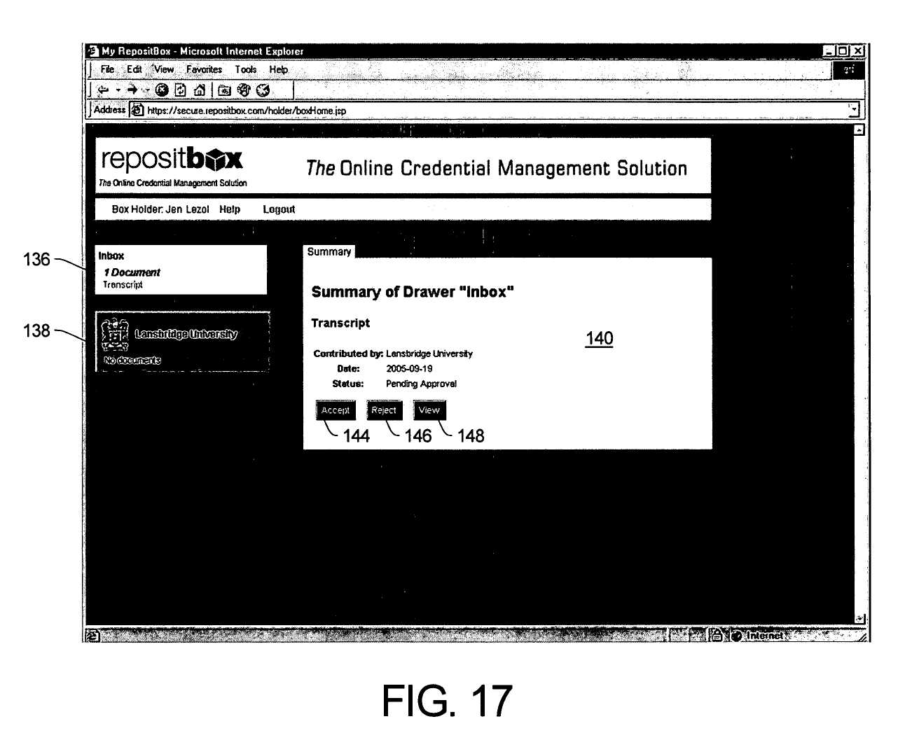

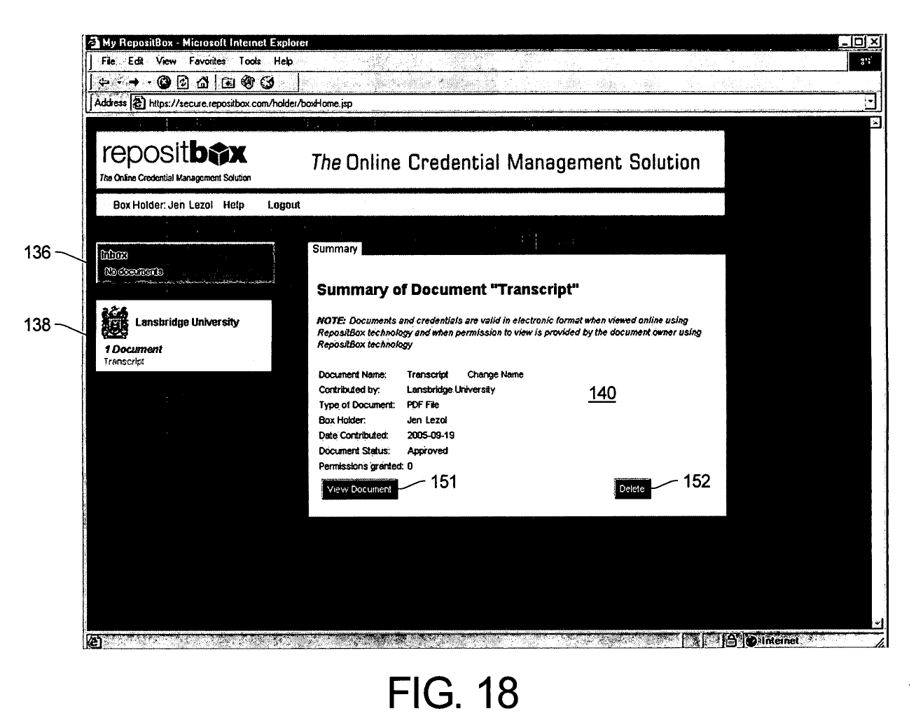

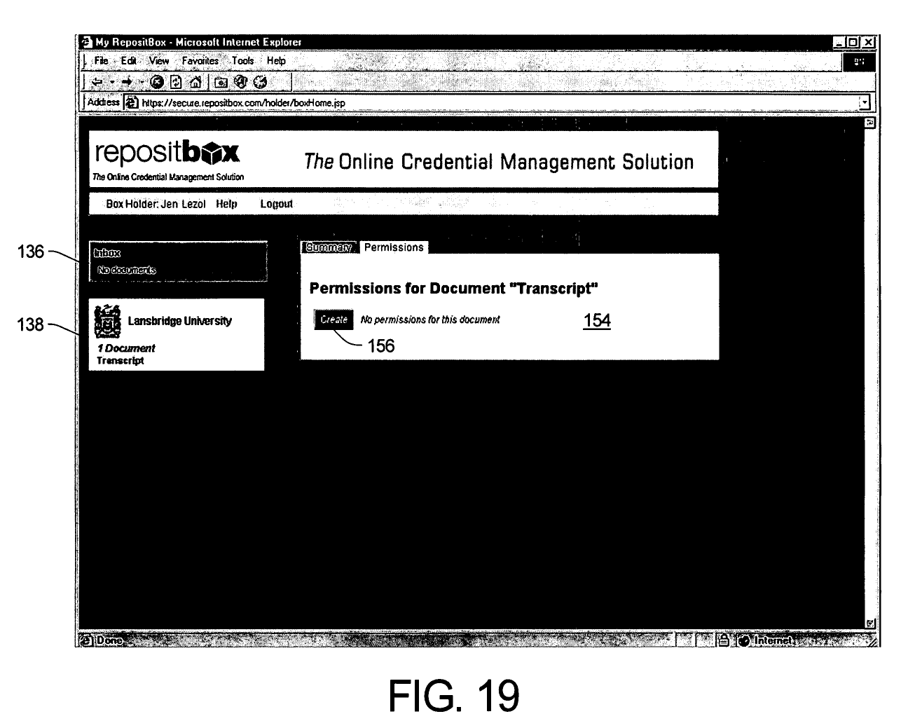

FIG. 17 is an internet browser display of a screen presented to the box holder 32 showing a listing of the documents in his or her inbox 136, a logo box 138 showing the document issuer 30 that provided the document, and a summary box 140 listing a summary of each of the documents in the inbox 136. At this time the box holder 32 has the option of accepting the document, rejecting the document or viewing the document by clicking the “Accept” button 144, the “Reject” button 146 or the “View” button 148, respectively, associated with each document. Clicking the “Accept” button 144 brings up the screen shown in FIG. 18; clicking the “Reject” button 146 brings up the screen shown in FIG. 19 if there are additional documents that the box holder 32 has previously accepted from the document issuer 30 shown in the box 138; and clicking the “View” button 148 brings up a new web page showing the document. After viewing the document, the box holder 32 closes the document page and chooses the “Accept” button 144 or the “Reject” button 148 (represented by box 149 in FIG. 2B).

FIG. 18 is an internet browser display of a screen presented to a box holder after the “Accept” button 144 in FIG. 17 has been clicked or after the “Reject” button 148 has been clicked if there is a previously accepted document from document issuer 30 shown in the box 138. FIG. 18 (represented by box 150 in FIG. 2B) displays a list of any accepted documents in the respective logo box(es) 138 for each document issuer 30. As can be seen in FIG. 18, the accepted document has been removed from the inbox 136 and placed in the logo box 136 of the document issuer 30 that provided the document. If there is more than one accepted document the box holder 32 can select one of the documents by clicking on it, and the summary box 140 is created for the document. If there is only one accepted document, the document is placed in the document box 140 automatically. The summary box 140 provides information about the document as shown in FIG. 18. The box holder 32 is given the options of viewing the document by clicking the “View Document” button 151 or deleting the document by clicking the “Delete” button 152. Clicking the “View Document” button 151 brings up a new web page showing the document. The box holder 32 is presented with a permission summary box 154 shown in FIG. 19 after the box holder 32 views the document and returns to the previous web page.

FIG. 19 is an internet browser display of a screen containing a permissions box 154 presented to the box holder 32 to allow the box holder 32 to create a permission for a viewer to see the document. Clicking the “View Document” button 151 in FIG. 18 brings up a new web page showing the document. After viewing the document, the box holder 32 closes the document page and the document name is presented to the box holder 32 in the permissions summary box 154. A “Create” button 156 is provided for the document to enable the box holder 32 to create a permission for a viewer 34 to view the document.

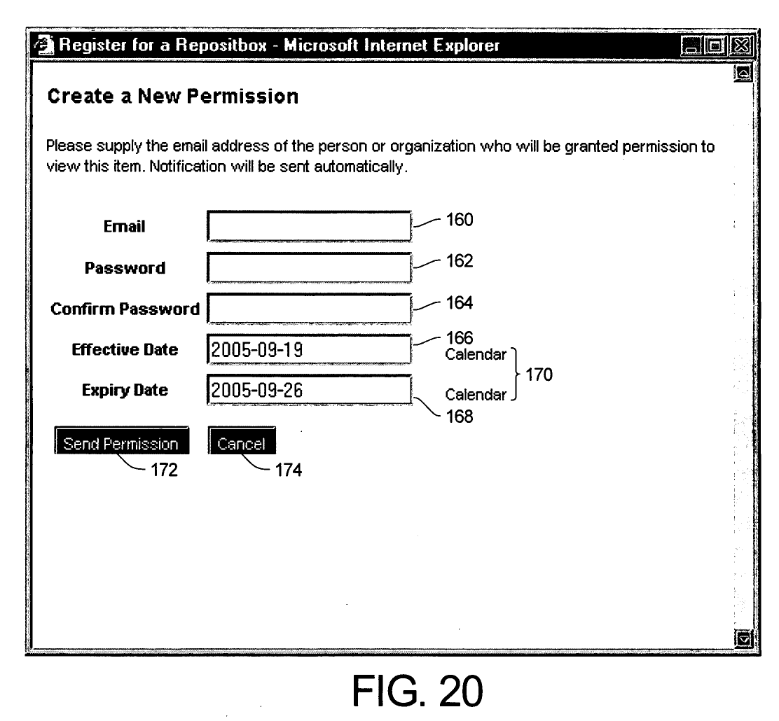

FIG. 20 is an internet browser display of a screen presented to the box holder 32 for entering the parameters of a permission after the “Create” button 156 in FIG. 19 has been clicked (represented by box 157 in FIG. 2B). Five text boxes enable the box holder 32 to input the e-mail address of a viewer 34 into box 160 and a password into boxes 162 and 164. An effective date and an expiry date are entered into date boxes 166 and 168, respectively, to define the duration of the permission. Calendar buttons 170 are provided to aid the box holder in entering the date information. The box holder then clicks a “Send Permission” button 172 to enable the permission and to instruct the credential management system 26 to notify the viewer 34 of the permission, or clicks a “Cancel” button 174 to cancel the permission.

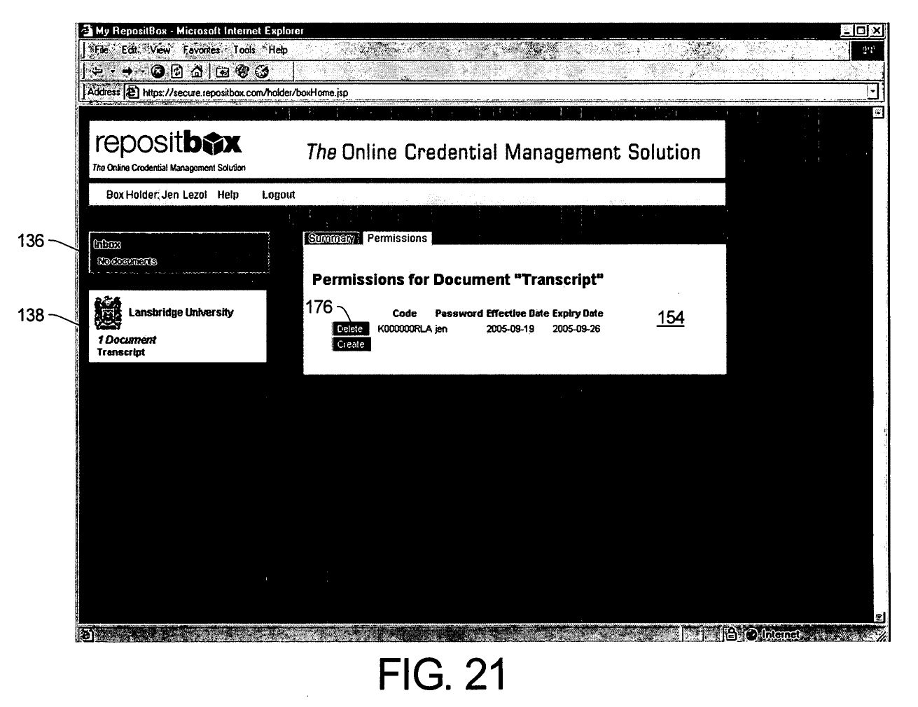

FIG. 21 is an internet browser display presented to a box holder 32 showing an updated permissions box 154 in FIG. 19. For each unexpired permission a “Delete” button 176 is provided to enable the box holder 32 to delete a previously created permission.

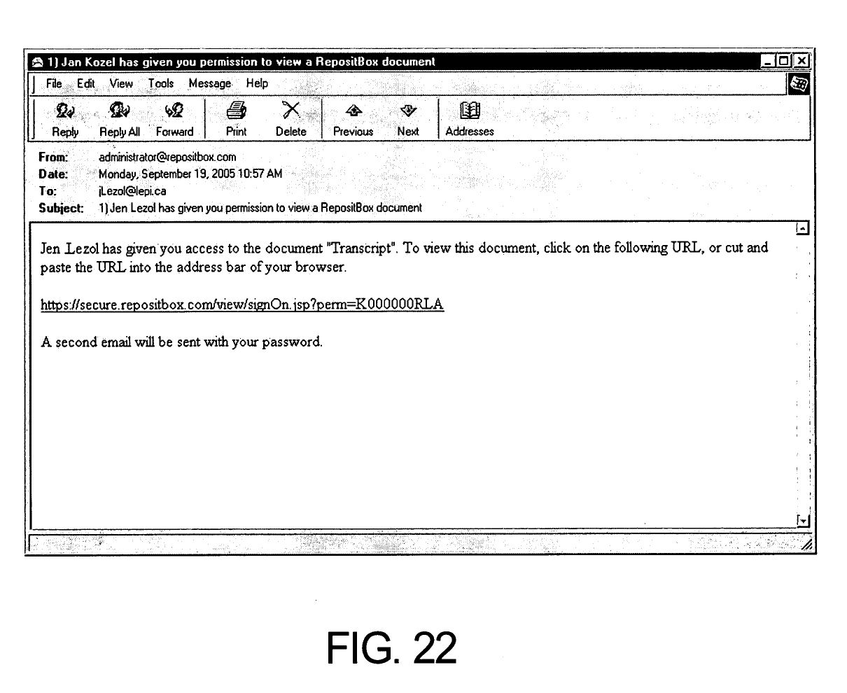

FIG. 22 is an e-mail display of a first e-mail sent by the credential management system 26 to the viewer 34 who has a document ready for viewing (represented by box 178 in FIG. 2B). The e-mail is sent after the box holder 32 has created a permission. The e-mail in FIG. 22 provides the name of the box holder 32 and the URL to be used to view the document.

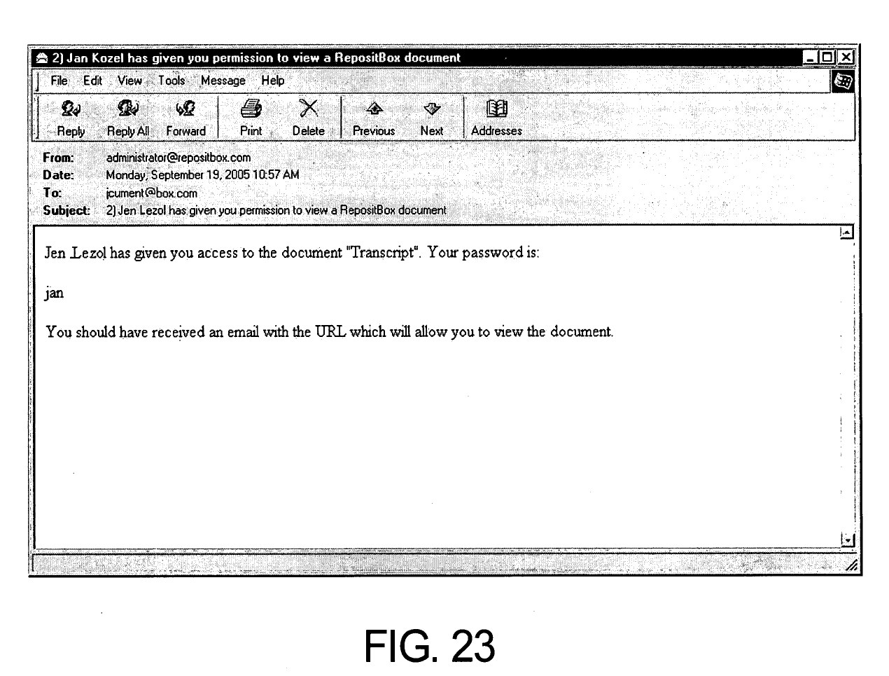

FIG. 23 is an e-mail display of a second e-mail sent by the credential management system 26 to the viewer 34 that has a document ready for viewing (also represented by box 178 in FIG. 2B). The e-mail lists the name of the box holder and the password to be used to view the document.

In a first interaction between an exiting box holder 32 responding to an e-mail of the type shown in FIG. 9 (represented by box 103 in FIG. 2B) by going to the credential repository 27 web site, the recipient is presented with a login screen to provide the user name and password (represented by box 180 in FIG. 2B) that was previously entered in the step described above with respect to box 114 of FIG. 2B for the document issuer 30 identified in the e-mail shown in FIG. 9. After the box holder 32 has logged in, the fee payment process begins as described above with reference to FIGS. 12 and 13, if applicable (represented by box 182 in FIG. 2B). If no fee is to be collected from the box holder 32, the fee payment process is skipped. Whether a payment is made or skipped, the box holder 32 is presented with the internet browser display in FIG. 17 for the document issuer 30 shown in the FIG. 9 e-mail (represented by box 135 in FIG. 2B), and proceeds with the steps as described above in the discussion in FIGS. 17-23. An existing box holder 32, who is not responding to either of the type of e-mails shown in FIG. 8 or 9, goes to the credential repository 27 web site (represented by box 104 in FIG. 2B) and selects a document issuer 30 from a list of document issuers 30 that have documents previously accepted by the box holder 32 as represented by box 83 of FIG. 2B. After selecting a document issuer 30, the box holder 32 enters the user name and password (represented by box 184 in FIG. 2B) previously entered for the document issuer 30 in the step described above with respect to box 114. After the box holder 32 has logged in, the box holder 32 is presented with a list of previously accepted documents (represented by box 150) shown in FIG. 18 and described above. The box holder 32 then proceeds with the steps described above with respect to FIGS. 19-23.

### Viewer Operation

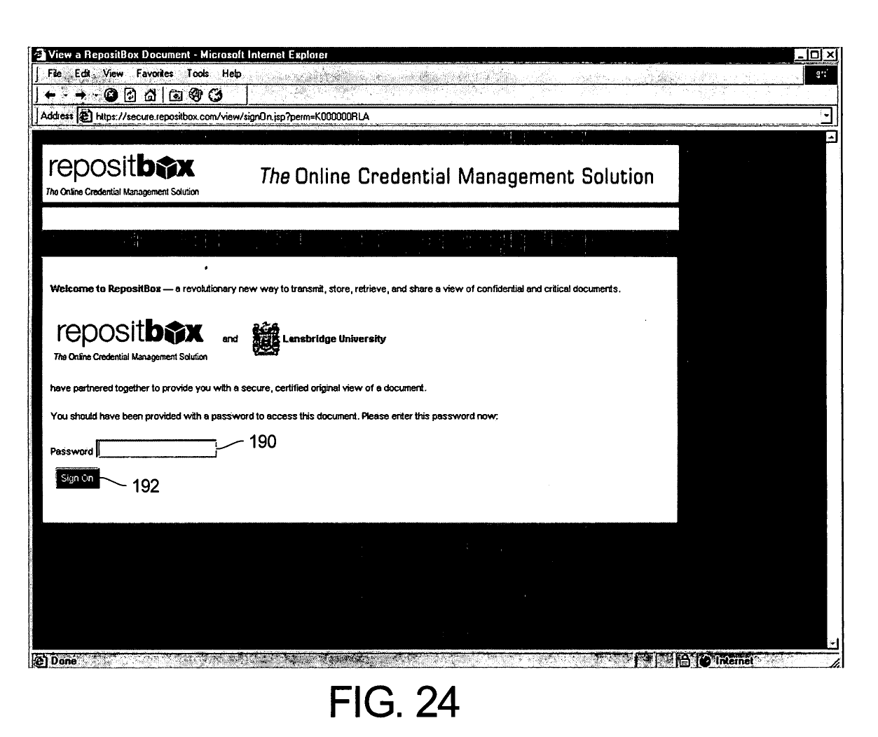

FIG. 24 is an internet browser display of a screen presented to a viewer for logging onto the credential management system 26 (represented by box 188 in FIG. 2C). A text box 190 is provided for the viewer 34 to enter the password provided in the second e-mail shown in FIG. 23. The viewer, after entering the password, would click the “Sign On” button 192 to view the document.

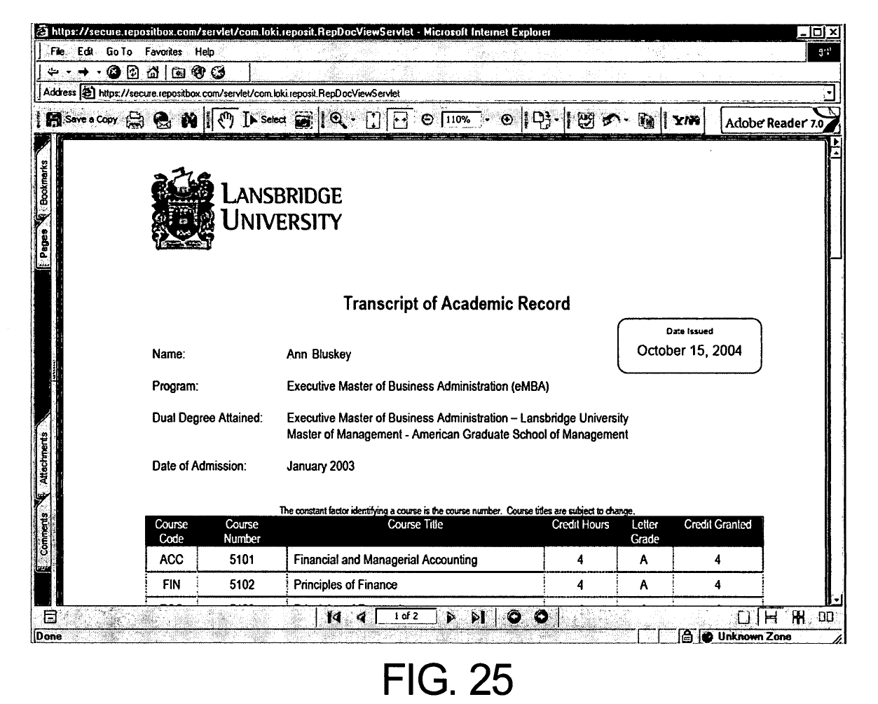

FIG. 25 is an internet browser display of a PDF document presented to the viewer after the viewer has logged on by clicking the “Sign On” button 192 shown in FIG. 24 (represented by box 194 in FIG. 2C). The document is presented in the PDF format to allow a viewer to directly view the document, to save the PDF document, and to print the document.

Thus there has been described a credential management system which is relatively inexpensive, secure, and convenient to use.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A method of managing a document comprising the steps of:
a) depositing said document in a repository of a document management system by a document issuer;
b) notifying a person associated with said document of the existence of said document in said repository by said document management system;
c) registering said person with said document management system;
d) notifying a third party of the availability of said document by said document management system in response to a request from said person to make said document available to said third party; and
e) providing access to said third party to said document stored in said repository.

2. The method set forth in claim 1 wherein step a) is performed in response to a request from said person.

3. The method set forth in claim 1 including the step of viewing said document in said repository by said document issuer at the request of said document issuer.

4. The method set forth in claim 3 further including the step of prohibiting said document issuer from modifying or deleting a document in said repository.

5. The method set forth in claim 1 wherein said document is initially stored in an inbox generated for said person when said document is transferred to said repository.

6. The method set forth in claim 5 wherein said document is moved from said inbox to another location only when said person accepts said document.

7. The method set forth in claim 6 wherein said step of depositing said document in said repository by said document issuer includes including in said document in a computer readable format the name of said person.

8. The method set forth in claim 7 wherein authentication information is also included in said computer readable format.

9. The method set forth in claim 1 including the additional step of providing the name of said person to said document management system prior to the transfer of said document.

10. The method set forth in claim 1 wherein said document is in a PDF format.

11. The method set forth in claim 1 wherein said document is in an XML format and is converted to a PDF document by said document management system by applying document in said XML format to a predetermined template.

12. The method set forth in claim 1 wherein said step of registering said person with said document management system includes requiring said person to provide answers to at least one verification question.

13. The method set forth in claim 1 wherein the step of notifying said third party of the availability of said document includes the steps of sending a first e-mail to said third party showing the URL where said third party may gain access to said document.

14. The method set forth in claim 13 further including the step of sending a second e-mail to said third party showing a password to be used by said third party to gain access to said document.

15. The method set forth in claim 1 wherein said step of registering said person includes the step of requiring the payment of a fee by said person.

16. A method of managing a credential comprising the steps of:
a) depositing said credential in a repository of a credential management system by a document issuer;
b) notifying a person associated with said credential of the existence of said credential in said repository by said credential management system;
c) registering said person with said credential management system;
d) notifying a third party of the availability of said credential by said credential management system in response to a request from said person to make said credential available to said third party; and
e) providing access to said third party to said credential stored in said repository.

17. The method set forth in claim 16 wherein step a) is performed in response to a request from said person.

18. The method set forth in claim 16 including the step of viewing said credential in said repository by said document issuer at the request of said document issuer but not allowing said document issuer to modify or delete said credential in said repository.
